(19) United States
(12) Patent Application Publication
(10) Pub. No.: US 2014/0047738 A1
(43) Pub. Date: Feb. 20, 2014

(54) Animated Slipper

(71) Applicant: Jorge Prats, River Edge, NJ (US)

(72) Inventor: Jorge Prats, River Edge, NJ (US)

(73) Assignee: TRISTAR PRODUCTS, INC., Fairfield, NJ (US)

(21) Appl. No.: 13/586,265

(22) Filed: Aug. 15, 2012

(51) Int. Cl. A43B 13/20; F16J 3/04; A43B 13/02

(52) U.S. Cl. 36/84; 36/103; 92/34

(57) ABSTRACT

A footwear, more particularly a slipper, comprising bottom portion including a cushioned sole and an air bellow-actuated mechanism utilizing a flat tensioning device to control the movement of portions of the slippers thereby providing an animated function such as an extension of a portion of a character positioned on the plush top of the slipper actuated as a result of the movement of the wearer of the slipper.

### FIELD OF INVENTION

The present invention relates generally to slippers, and more particularly to children's slippers that have an air bellow-actuated mechanism to provide an animated function such as an extension of a portion of a character positioned on the plush top of the slipper.

### BACKGROUND OF THE INVENTION

Conventional footwear has been designed for the purpose of safely, comfortably, and efficiently contacting the ground while traveling by foot. A type of conventional footwear which relates to mainly indoor travel is commonly referred to as slippers. Slippers are generally a semi-closed type of indoor shoe which consist of a sole held to the wearer's foot by a strap running over (or between) the toes or instep. Slippers are generally soft and lightweight compared to other types of footwear. Slippers are mostly made of comforting materials that allow a certain level of comfort for the wearer and in some instances the slipper may employ certain characteristics that allow for limited outdoor use such as a partial rubber sole of the like.

One form of slippers that are commonly used by children is the novelty slipper. Novelty slippers are designed to bring a form of enjoyment or entertainment to the wearer. Forms of novelty slippers in the art include nightlight slippers, noise emitting slippers, moving portions slippers, plush character slippers such as footwear designed to resemble animals, fanciful creatures, or recognizable characters, and slippers designed for a dual-purpose such as to be used as a slipper but also as a hand puppet. For example, Tann U.S. Pat. No. 3,023,420 entitled “Slipper Sock” claims a combination slipper sock and puppet head. In this particular invention, a slipper sock includes a puppet, as depicted as a dog, mounted on the toe of the sock. As disclosed, as a wearer of the sock walks or wiggles his or her toes, the puppet head bobs up and down and as a result of the motion of the feet, the upper portion of the mouth moves up and down from the lower portion, mimicking the opening of the dog's mouth. Further, the puppet sock can also be removed from the wearer's foot so that the wearer can utilize the removed portion as a hand puppet.

Similar to the Tann disclosure, Rosen U.S. Pat. No. 3,226,849 entitled “Slipper and Toy” discloses a slipper that may also be used as a hand puppet. According to the disclosure, “the object of the [Rosen] invention is to provide a decorative slipper to be worn and used on the foot in the customary manner, but one that is adapted alternatively to be used on the hand and grasped with the fingers.”

As mentioned, it is known in the art for footwear to include an activated light bulb designed to illuminate when the wearer takes a step. Rovinsky U.S. Pat. No. 4,324,054 teaches a child's slipper having a nightlight which may be selectively actuated by the slipper flexing with each step of the child. The patent discloses an electrical circuit having a mechanical switch that closes the circuit and powers a light.

In another example of a novelty slipper, Villar U.S. Pat. No. 5,058,293 entitled “Footwear with Animated Face” discloses novelty footwear in which a simulated face is disposed on the upper part of the footwear and the eye portions rotate in a clockwise and counterclockwise direction as the wearer walks. The change in eye position is accomplished with mechanical treadle means designed to manipulate the manipulate mounted eyes (formed from common ping pong balls) resulting in the rotation of the eyes about the mounts to mimic a change in a facial feature.

Other actuation methods are known in the construction of footwear. For example, mechanical actuation can be provided by the use of a switch or a treadle. Matsuda U.S. Pat. No. 3,738,024 teaches footwear with an ornament that inflates when a hollow space is depressed. The Matsuda technology incorporates a closed air system and uses the exploded ornament to form part of the actuating mechanism reducing the adaptability of the mechanism to other movable parts. A second embodiment depicted in the Matsuda disclosure involves a spring inside of an air bag to effect the restoration of the system after the hollow space has been depressed. The addition of the spring in cooperation with the air bag results in a combined volume nearly twice as large as conventional air bag inflation systems.

Air system technology is well known in the art related to footwear for providing and retaining a custom fit for the user. For example, Goldston U.S. Pat. No. 5,588,227 entitled “Athletic Shoe Having Air Bladder Pressure Indicating Means” employs a combination open air system that introduces air into an air bladder which increases the pressure of a shoe to conform to the wearer's foot. This specific system includes a pressure release valve to allow trapped air to escape. The attractiveness of the air bag and bellows system is apparent in that it uses air, which is an inexpensive and abundant substance.

In another example of such a system, Kinan U.S. Pat. No. 6,681,504 discloses footwear that simulates a reptile, more specifically a chameleon. The footwear includes an air pad that controls the expelling and hissing of a retractable tongue as well as an electrical means to cause the eyes to illuminate. The tongue is connected at the toe section of the footwear. Kinan utilizes an open air system with an opening at the end of the tongue to expel air from the air pad and pressure release valves to ensure that overpressure does not cause an explosion of the pad if the pad receives too much pressure. The retractable tongue can also be removed should the desire arise.

While the aforementioned apparatuses are generally suitable for a particular purpose, such apparatuses are not sufficiently suitable for the purpose discussed in the present invention. The aforementioned disclosures capitalize on the entertainment or enjoyment factor of novelty footwear, and in some cases the improved comfort of footwear by introducing air-padding systems. Similarly, the present invention seeks to take advantage of the ability for novelty footwear to be comfortable, useful, and entertain the wearer, as well as others viewing the use by the wearer, by including fanciful creatures or characters and bright colors to appeal to the wearer, particularly children. As stated, the existing art has created a need for entertaining novelty slippers that efficiently inflate with smaller, less expensive inflation systems. The prior art systems, including complicated expansion systems, oftentimes incorporating electronic elements and complicated return springs also creates a multitude of problems which requires a solution. Both of these needs are fulfilled by the present invention. Specifically, the unique air bag and flat tension design allows for increased volume relative to the size of the air bag, thus providing for cheaper and more efficient inflation systems. Another benefit of this invention is that the actuation mechanism provides for adaptability and use for various reactions as needed to simulate advanced movement to more closely mimic characters, animals, and the like.

### SUMMARY OF EMBODIMENTS OF THE INVENTION

As a result of the developments and the shortcomings in the known art in the respective field, a footwear, such as a slipper, is disclosed improving upon various prior art slippers known in the art by employing a unique closed air system in conjunction with an air bag and flat tension configuration to increase the volume of inflation and solve several problems present in the prior art. Particularly, the present invention employs a closed air system to provide the sensitivity needed to achieve multiple positioning for animated characters integrated with a slipper enabling the user to activate the character in a life-like fashion. For example, the novelty slippers are designed to mimic or animate actions like talking, panting, barking, and etc. commonly affiliated with a particular character, such as a dog, kitten, dinosaur, monster, or any other like character designed to be recognized by so as to excite, entertain, and connect with a child. The air-based system is positioned so that a wearer can actuate the system through normal bipedal movement commonly associated with human movement such as when the wearer walks, runs, skips, jogs, or the like.

In order to accomplish the objectives of the present invention, a first embodiment of the present invention involves a novelty slipper exhibiting certain characteristics of a character, often including the head of a character positioned on the forward facing upper portions of the slipper designed to accomplish certain movement which is actuated by an air-based transfer bellows system. The transfer bellows system can also utilize a flat tensioning device to control the movement of portions of the slippers by limiting the extension of certain portions or retard the movement of the designated portions of the slipper.

In a further embodiment of the present invention, the novelty slipper is designed to allow for accompanying light to be generated by actuating the novelty slipper or the use of materials exhibiting phosphorescent, chemiluminescent, or like characteristics.

Another embodiment of the invention provides for the animation of the character by presenting accompanying noise, triggered along with the character animation generated by actuating the novelty slipper.

Another embodiment of the invention allows for scents to be normally contained but released as a result of actuating the novelty slipper.

Turning to the next embodiment of the present invention, the novelty slipper can incorporate other movable parts positioned at various points on the novelty slipper such as the toe portion of the slipper or on the sides of the sole portion of the slipper to extend perpendicularly and generated by actuating the novelty slipper.

In a further embodiment, the novelty slipper of the present invention incorporates the elements above but with a flat tension limiter that is restrained at a middle point in addition to its terminal points.

Other systems, methods, features and advantages of the invention will be, or will become apparent to one skilled in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

A further understanding of the present invention and its objectives other than those set forth above can be gained by reference to the various implementations set forth in the illustrations of the accompanying figures. Although the illustrated implementations disclose certain aspects of the present invention, the apparatus and method of use of the invention, in general, together with further objectives and advantages thereof, may be more easily understood by reference to the drawings, examples, and the following description. The figures are not intended to limit the scope of this invention, which is set forth with particularity in the claims, but merely to clarify and exemplify the invention. The detailed description makes reference to the accompanying figures described briefly as follows:

FIG. 1 is a cross-sectional side view of the present invention showing the position of the wearer's foot therein and wherein the bellows are depicted in an un-actuated state and the airbag is not inflated.

FIG. 2 is a cross-sectional side view of the present invention showing the position of the wearer's foot therein and wherein the bellows is depicted in actuated state and the airbag is inflated.

FIG. 3 is a perspective view of a single bellow depicted in un-actuated state.

FIG. 4 is a perspective view of a two-way coupler valve with a first fitting end having a greater diameter than the opposite fitting end.

FIG. 5 is a perspective view of a two-way coupler valve exhibiting equal diameter fitting ends for connection to a flexible hose.

FIG. 6 is a perspective view of a T-splitter type three-way coupler valve exhibiting equal diameter fitting ends for connection to a flexible hose.

FIG. 7 is a perspective view of a Y-splitter type three-way coupler valve exhibiting equal diameter fitting ends for connection to a flexible hose.

FIG. 8 is a top view of the airbag of the present invention depicted after inflation, exhibiting an actuated state.

### DETAILED DESCRIPTION OF THE DRAWINGS

Detailed descriptions of the aforementioned embodiments of the present invention are disclosed herein. However, techniques of manufacture and resulting structures in accordance with the present invention may be embodied in a wide variety of forms and modes, some of which may be quite different from those in the disclosed embodiments. Consequently, the specific structural details disclosed herein are merely representative, yet in that regard, they are deemed to represent suitable implementations for purposes of disclosure and to provide a basis for the claims herein, which define the scope of the present invention.

Moreover, well known methods, procedures, and substances for both carrying out the objectives of the present invention and illustrating the preferred embodiment are incorporated herein but have not been described in detail as not to unnecessarily obscure novel aspects of the present invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or,” in reference to a list of two or more items, covers all of the following interpretations of the word: any of the items in the list, all of the items in the list, and any combination of the items in the list.

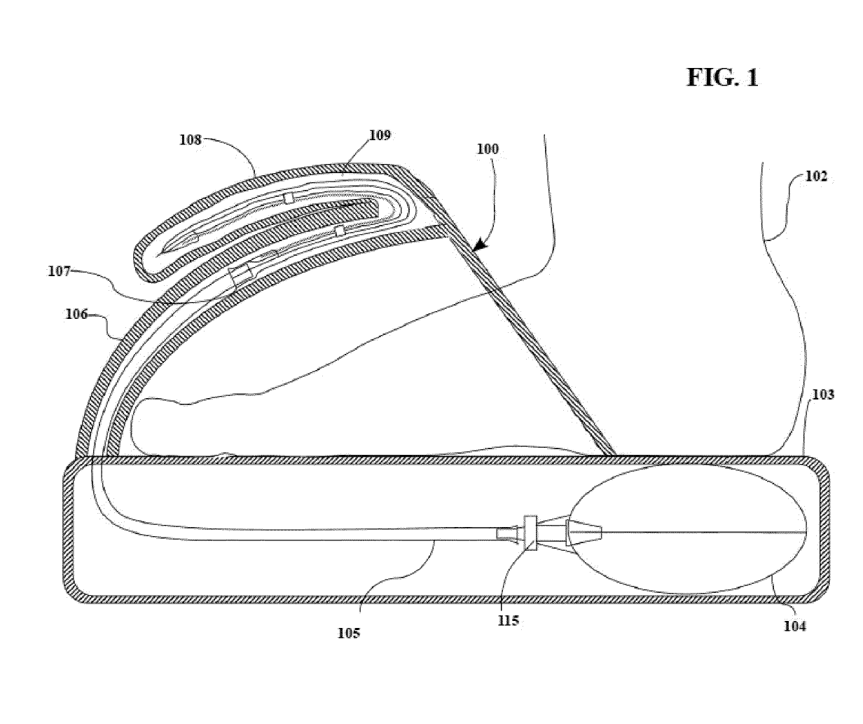

Turning to FIG. 1, depicted is an embodiment of a slipper 100 having a closed air system that allows for multiple positioning of an animated character. In ordinary fashion, the wearer's foot 102 is shown inside the slipper. The slipper 100, manufactured of cushioned and generally comfortable material common in the art, snugly accommodates the wearer's foot when the foot is in a relaxed state or in a state of tension as well during periods of movement as a result of the wearer walking, jogging, skipping, running, etc. While the designs of the present invention, exhibiting comical or entertaining depictions of animals, characters, human caricatures, etc., are geared to excite and entertain children, one of ordinary skill in the art will readily recognize that the improved actuating system of the present invention may be employed in a variety of modes to appeal to wearers of all ages, demographics etc.

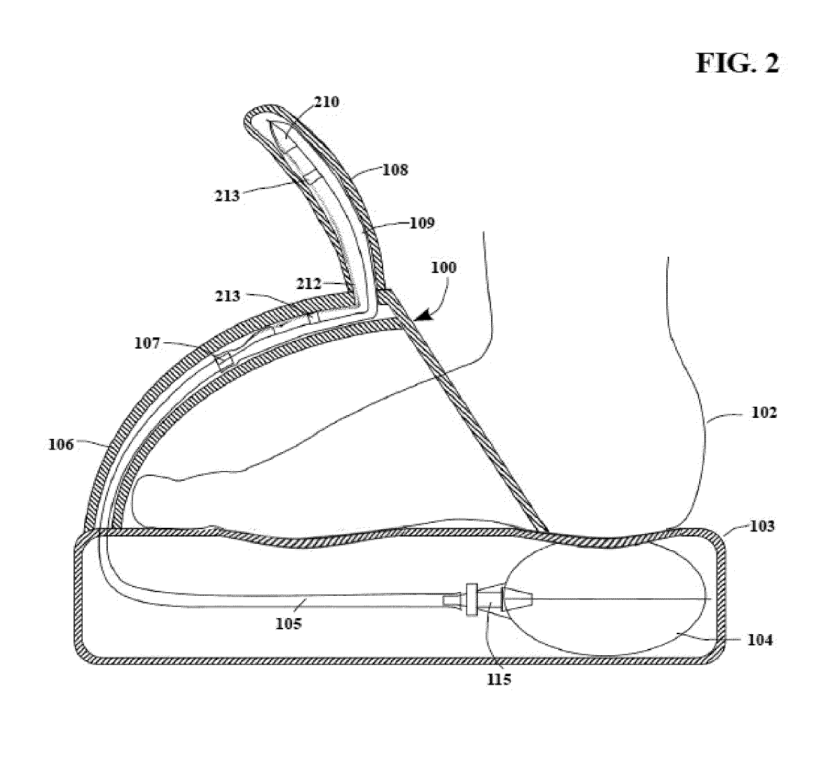

Slipper 100 includes a cushioned sole 103 extending the bottom portion of slipper 100, the dimensions of which are established based on the various sizes of human feet. Cushioned sole 103 provides the foundation of the slipper 100 and is manufactured of resilient foam such as visco-elastic foam or like material common in the manufacture of slippers capable of managing the forces typically exerted on footwear by a human. The resilient foam is generally encased in a plush material such as silk with cotton backing or synthetic fibers such as polyester or the like. This encasing material is generally designed to feel comfortable to a wearer of the slipper 100. Closed air-filled bellow 104 is positioned within cushioned sole 103 at the rear portion of cushioned sole 103 so that the heel portion of a wearer's foot 102 impacts and compresses bellow 104 when the wearer's foot 102 impacts the ground as a result of the bipedal movement of the wearer (the action of which is further described with respect to FIG. 2 herein). Bellow 104, as well as the other portions of the closed system disclosed herein, are manufactured of commonly-available plastic material or similar material capable of preventing air from expelling from the closed system. A preferred embodiment of the air bag also includes a powder to absorb any moisture that may be present within the air bag and interfere with its inflation.

In the embodiment presented in FIG. 1, bellow 104 is connected at a first end to flexible air hose 105 via coupler valve 115. Coupler valve 115 is a two-way valve allowing for the flow of air into flexible hose 105 once bellow 104 is compressed and the ingress of air from flexible hose 105 as bellow 104 returns to static position. Flexible hose 105 travels through slipper upper 106 in a contained chamber of slipper upper 106 and connects to air bag 109 via a connector 107. Connector 107 is designed to allow for the ingress and egress of fluid, in this instance air, while providing a direct connection between flexible hose 105 and air bag 109. Air bag 109 is primarily resident in extension 108. Extension 108 is the portion of slipper upper 106 that is designed to move in a plurality of directions, in this case upwards as compared to the position of slipper upper 106. FIG. 1, depicts extension 108 at its static or un-actuated position (i.e., air bag 109 resident in extension 108 is not inflated).

In contrast to FIG. 1, FIG. 2 depicts extension 108 at an actuated position (i.e., air bag 109 resident in extension 108 is inflated). As discussed with respect to FIG. 1, FIG. 2 depicts the preferred embodiment of a slipper 100 having a closed air system that allows for the multiple positioning of an animated character. In ordinary fashion, the wearer's foot 102 is positioned inside the slipper. Slipper 100 includes a cushioned sole 103 extending along the bottom portion of slipper 100, providing the foundation of the slipper 100. Closed air-filled bellow 104 is positioned within cushioned sole 103 at the rear portion of cushioned sole 103 so that the heel portion of a wearer's foot 102 impacts and compresses bellow 104 when the wearer's foot 102 impacts the ground as a result of the bipedal movement of the wearer as shown. This compression of bellow 104 results in the transfer of fluid (i.e., the egress of air) from bellow 104 through flexible air hose 105 via coupler valve 115 and ultimately into air bag 109 via connector 107. The fluid transfer exerts expanding forces on the inner walls of all portions of the closed air system as it travels through the system. In certain portions of the closed-air system the material utilized is designed of sufficient dimension and strength to substantially counteract this fluid force, such as in the case of the flexible air hose 105 and any connections utilized, including coupler valve 115 and connector 107. In other portions of the closed-air system, the material of manufacture of certain components are designed to allow for the fluid flow to expand the inner walls and effectively the outer walls of particular components such as air bag 109. As a result of this ability to expand portions of the closed air system, certain extensions of slipper 100 can be actuated, thereby creating the desired animation of slipper 100. As mentioned, bellow 104, at its static state, is expanded as a result of the force expended on its inner walls by the internal fluid, in this case air, when compressed by the force of a human and returns to static position after it is compressed by allowing for the ingress of returning air to bellow 104.

In the particular embodiment presented in FIG. 2, bellow 104 is connected to a first end of flexible air hose 105 via coupler valve 115. Coupler valve 115 is a two-way valve allowing for the flow of air into flexible hose 105 once bellow 104 is compressed and the ingress of air from flexible hose 105 as bellow 104 returns to static position. Flexible hose 105 travels through slipper upper 106 in a contained chamber of slipper upper 106 and connects to air bag 109 via a connector 107. Connector 107 is designed to allow for the ingress and egress of fluid, in this instance air, while providing a direct connection between flexible hose 105 and air bag 109. Air bag 109 is resident in extension 108. Extension 108 is the portion of slipper upper 106 that is designed to move in a plurality of directions, in this case upwards as compared to the position of slipper upper 106. Compressing bellow 104, generally as a result of wearer's heel applying vertical force on the cushioned sole 103 extending along the bottom portion of slipper 100, results in the transfer of fluid through the closed air system and into the air bag 109. This transfer of fluid into the air bag 109 results in an expanding force on the inner walls of air bag 109 which in turn expands air bag 109. Since air bag 109 is resident in extension 108, expansion of air bag 109 results in movement of extension 108. Of course one of ordinary skill in the art will recognize that since the novelty slippers of the present invention are designed to mimic or animate actions like talking, panting, barking, and the like, which are commonly affiliated with a particular character, such as a dog, kitten, dinosaur, monster, or any other like character, extension 108, and the corresponding closed-air system designed to animate extension can be manufactured in a myriad of configurations to accomplish such animation. For example, as shown in FIG. 2, extension 108 can be the upper portion of a character's mouth and the movement can be an upward movement mimicking the opening of a mouth. The movement can also be the extension and retraction of a tongue or teeth of a character. In another example, the eyes or eye brows of a character can be raised or ears of a character can be designed to “perk up” thereby changing the expression of the character. In a further example, arms may be designed to extend outward in a substantially horizontal plane.

While FIG. 2 depicts a single closed-air system designed to accomplish the referenced movements of extension 108, one of ordinary skill in the art will also readily understand that a plurality of extensions 108 or components of a closed-air system such as a plurality of air bags 109 may be employed to create certain movements. For example, two extensions 108 with two resident air bags 109 may be used to allow two ears to independently “perk up” or two eyebrows may independently be raised. Of course, a single bellow 104 may accomplish this desired movement or a plurality of bellows 104 may be employed. Bellow 104 may also be comprised of two or more compartments connected to two or more air hoses which lead to independent air bags 109. This embodiment allows the wearer to shift the force of the fluid by transferring the wearer's weight and depressing a portion of the bellow 104 in order to actuate one extension 108 of the slipper 100 at a time. Specifically, this type of system can be combined with a character that has ear or eye movement to allow the wearer to actuate one ear or one eye at a time, leading to enhanced control over the actions of the slipper 100. Such animation can also be accomplished by utilizing a specialized connector or series of connectors at a point within the closed air system that diverts fluid to a predetermined position within the system.

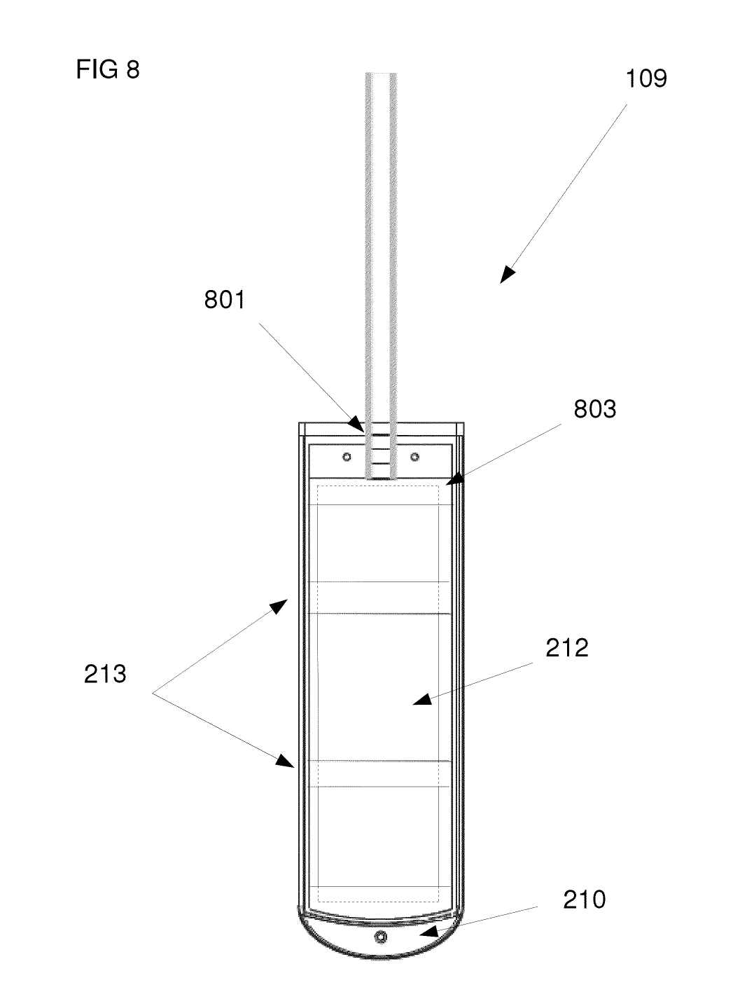

FIG. 2 provides further detail of the constricting mechanism of air bag 109 including the flat tension 212 to control the movement of portions of the slipper 100 by limiting the extension of certain portions or retarding the movement of the designated portions of the slipper 100. Flat tension 212 is positioned and loosely connected to air bag 109 by upper restraining pocket 210 (a lower restraining pocket may also be employed as shown in FIG. 8) and a plurality of restraining bands 213, in this case two restraining bands 213. Restraining pocket 210 restricts the vertical movement of flat tension 212 so that flat tension 212 remains loosely positioned alongside air bag 109 generally restricting movement without preventing the inflation thereof. Restraining bands 213 restrict the horizontal movement of flat tension 212 so that flat tension 212 remains loosely positioned alongside air bag 109 generally restricting movement without preventing the inflation thereof. In the air bag 109 inflated position (as a result of fluid expelled from bellow 104 upon compression), the cylindrical inflation of the air bag 109 forces flat tension 212 to straighten from a flaccid and bent state and bow outwardly. Upon inflation, the tension in flat tension 212 acts against the inner side of the extension 108 and the restraining pockets. The flat tension 212 is overwhelmed at the middle hinge which allows for the tension to force a bulge between the middle hinge and the pocket restraints thereby further restricting movement of air bag 109 and targeting the expansion of extension 108. Flat tension 212 is manufactured of sufficiently rigid material so that once compression on bellow 104 is removed (i.e., the wearer's force from the foot is generally released), flat tension 212 forces the constriction of air bag 109 thereby reducing the dimensions of air bag 109 and expelling the air therefrom returning it to available voids in the closed air system, primarily the void in the bellow 104.

This construction employing the use of flat tension 212 is designed to overcome the various problems encountered in the prior art. Generally, the use of air-based systems is heavily constrained causing the components of the system to stick to the air bag thereby inhibiting its inflation. Such constriction can lead to failure to inflate or airbag blowout. The preferred embodiment of the present invention utilizes only two restraining pockets at the longitudinal ends of the spring which allows for generally free movement of the air bag in conjunction with the flat tension 212 thereby avoiding the prior art problem of system components sticking. The present invention also remedies the failure common in the art by allowing full inflation of the air bag. Specifically, the preferred embodiment of the present invention allows for the movement between the restraining pocket 210 and plurality of restraining bands 213. The effect is that the flat tension 212 is free to bow as a result of its construction.

It is further contemplated by the present invention that the slipper 100 can also include a means for producing sound in addition to the caricature animation. A noise making device (not shown) may be placed within the inflation system at a point between the bellow 104 and air bag 109 which activates and produces noise as air passes it. This device may be configured to produce varying sounds depending on which direction the air is flowing. The slipper 100 may include a circuit with a switch that closes as the bellows is depressed, which leads to the creation of the sound. This embodiment may also employ an open air system to enhance the noise production.

An embodiment may also include an area within the slipper 100 or closed air system which is only exposed as the animation is actuated. This area can include a pocket or other means for holding a scent substance such as a scented oil or incense. Whereby the scent is released as the slipper is actuated.

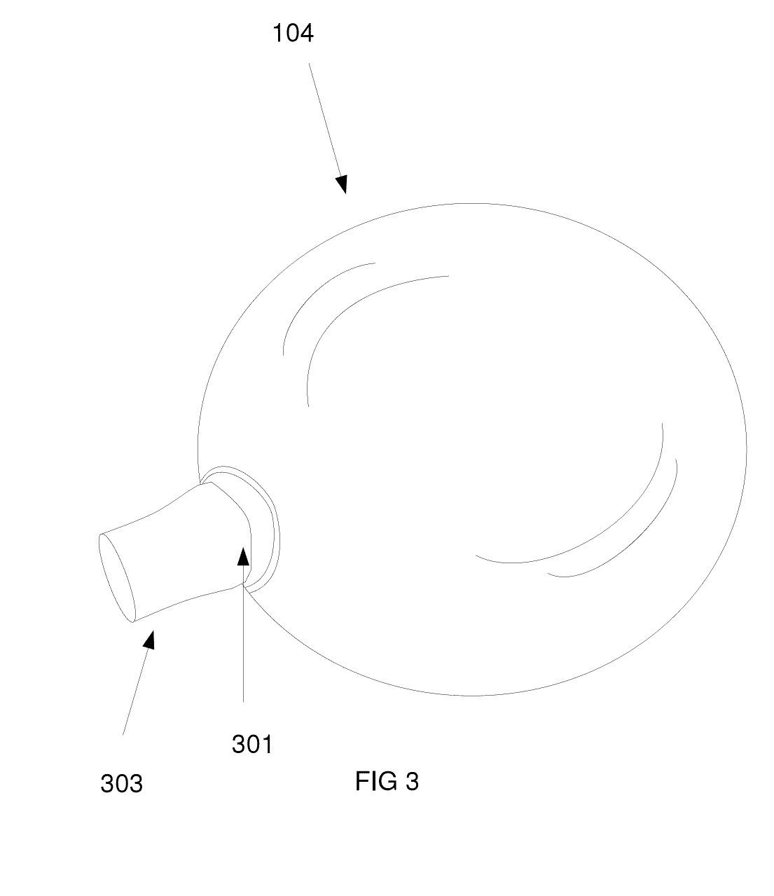

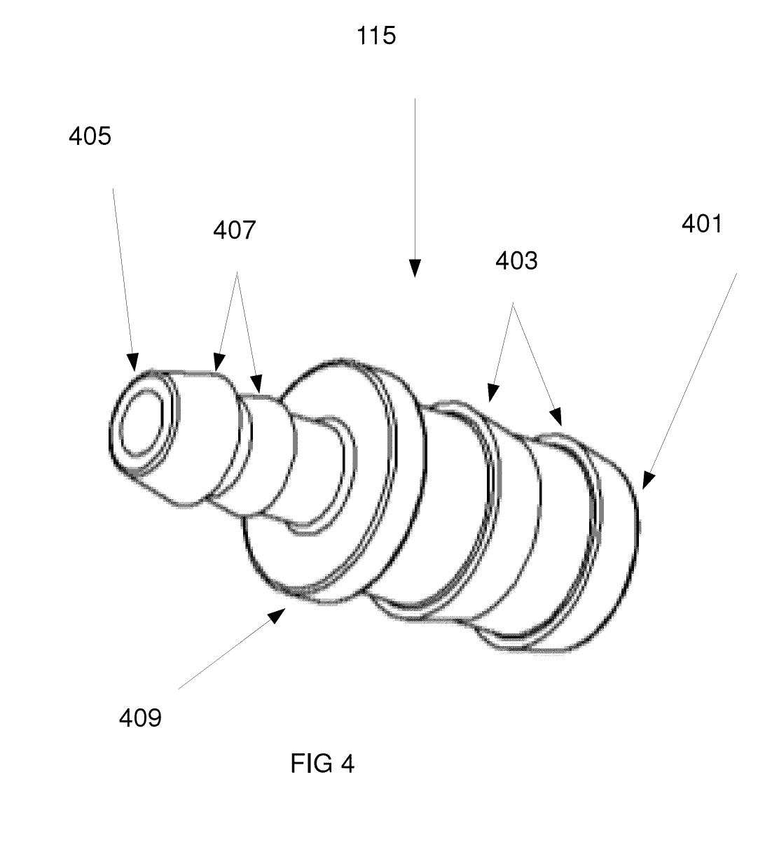

Turning next to FIG. 3, FIG. 3 presents a more complete description of bellow 104 as referenced in FIG. 1 and FIG. 2. Bellow 104 is manufactured of sufficient material and size so as to remain at static expanded position as a result of the force expanded on its inner walls by the internal fluid, in this case air. Bellow 104 is further designed to be compressed by the force of a human and return to static position after this force is released by allowing for the ingress of returning air to bellow 104. The shape of the bellow 104 can be any form that allows for efficient expulsion of air from the bellow 104 and into the other components of the closed air system. In addition to bellow 104, the closed air system is comprised of a plurality of valves and connectors depending on the desired configuration of slipper and intended movement of the animation of slipper. FIG. 3 further depicts the opening 301 of the bellow 104 through which the fluid, in this case air, flows. Opening 301 can be of any shape that will efficiently and safely allow for expulsion of air from the bellow 104 and inflow of air from other portions of the closed air system as depicted in the previous figures. Opening 301 of bellow 104 terminates at coupler receiver 303. Coupler receiver 303 is configured to receive a coupler valve (depicted in FIG. 4) or directly communicate with the flexible hose such that air flow can travel to and from bellow 104. The particular embodiment of bellow 104 depicted in FIG. 3 is an oblate spheroid with a coupler receiver 303 configured to receive a coupler valve, but of course one of ordinary skill in the art will readily recognize that a myriad of shapes and dimension may be employed to accomplish the desired operation.

To further clarify the structure of the present invention presented in FIG. 1 and FIG. 2, FIG. 4 depicts a perspective view of a coupler valve 115 having a first end, bellow end 401, with a larger diameter than the opposing second end, hose fitting end 405. Bellow end 401 of the coupler valve 115 is configured to communicate with the coupler receiver of the bellow. The diameter of bellow end 401 is designed of sufficient dimension to provide a tight fit with coupler receiver 303 so that air cannot escape from the closed-air system. Bellow fitting end ridges 403 are added to the coupler valve 115 to assure this fit between coupler receiver and bellow fitting end 401 of coupler valve 115, thereby increasing the efficiency of the closed-air system. The particular embodiment depicts two ridges, however, one ordinarily skilled in the art can envision any number of ridges to effectuate this goal. In a similar fashion, the hose fitting end 405 of the coupler valve 115 is configured to make a tight fit with flexible hose. Hose fitting end ridges 407 increase the contact of the fit between the hose fitting end 405 of the coupler valve 115 and the flexible hose. The particular embodiment depicts two ridges, however, one ordinarily skilled in the art can envision any number of ridges to effectuate this goal. Hose stop 409 ensures that neither the bellow tube nor the flexible hose travel more than approximately half the length of the coupler valve 115. The hose stop 409 also serves as a final point for attaching the tubes such that a manufacturer is aware of the optimal connection of the tubes during manufacture. The particular embodiment shows a two-way connector but more outflows may be utilized in order to effectuate the goals desired to be achieved in this particular embodiment.

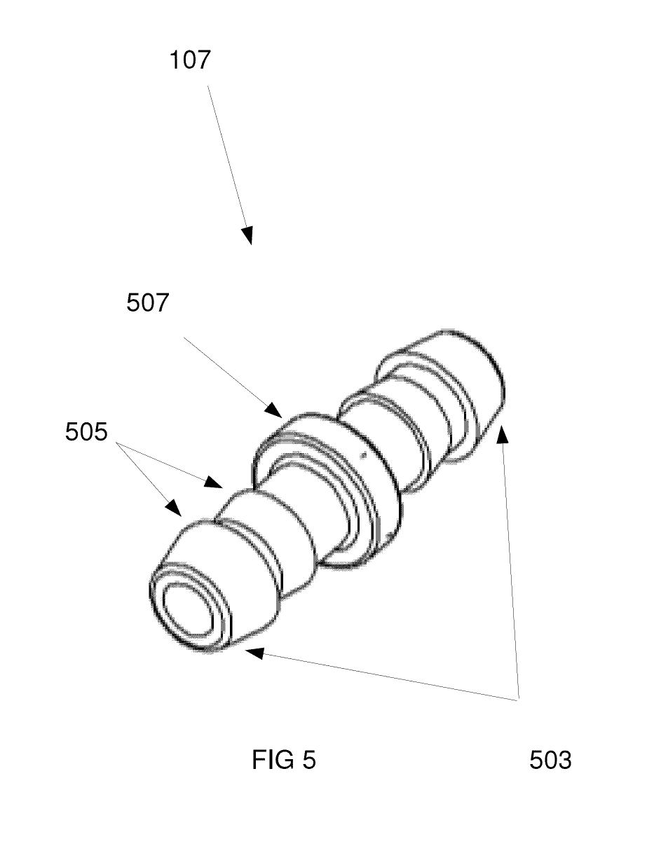

Next, FIG. 5 presents further detail of the components utilized to construct the closed-air system of the present invention. FIG. 5 depicts connector 107 having fitting ends of equal diameter. This particular connector 107 is generally useful for the in-line connections between the fitting hose and other components which exhibit similar dimensions, such as in this instance between the air bag and the flexible hose as shown in FIG. 1 and FIG. 2. The fitting ends 503 can be used interchangeably allowing the manufacturer greater leeway in production thus increasing efficiency and lowering production costs. Ridges 505 function in a substantially similar manner as the ridge design of the coupler valve embodiment of FIG. 4, whereby the ridges 505 increase the fit between the valve and the tubing to increase the strength and efficiency of the closed-air system. The hose stopper 507 ensures proper attachment of the tubing to the connector 107 achieving the same goals as mentioned above.

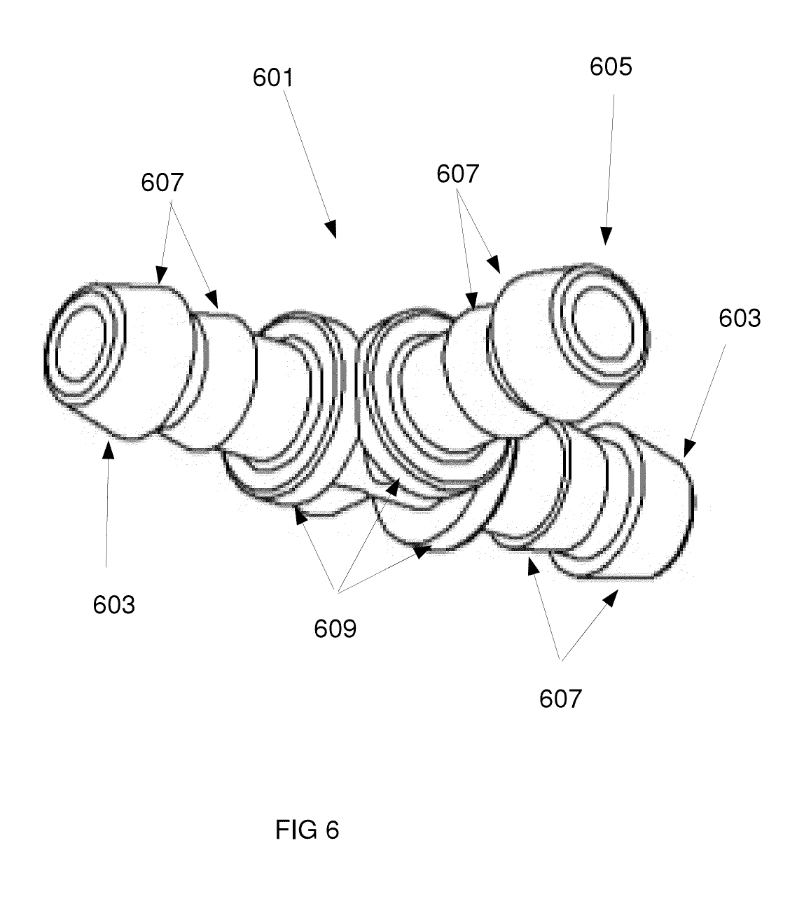

In addition to the use of an in-line connector as detailed in FIG. 5, a specialized connector such as the T-splitter 601 of FIG. 6 may be utilized in an alternate embodiment of the present invention to provide specific animation of the novelty slippers disclosed herein. T-splitter 601 comprises two air bag fitting ends 603 designed to connect to two, ultimately independent air bags. T-splitter 601 is configured with adapting ridges 607 to increase the tightness of the fit between the air bag fitting ends 603 and air bags. T-splitter 601 has a third, flexible hose fitting end 605 which is designed to be connected to a flexible hose. Flexible hose fitting end 605 is configured with adapting ridges 607 to increase the tightness of the fit between the flexible hose fitting end 605 and the flexible hose. Both the air bag fitting ends 603 and flexible hose fitting end 605 are configured with hose stops 609 which act as a final terminus for the connected air bags 109 and flexible hose 105, respectively. The hose stops 609 ensure proper fit of all attaching hoses thereby increasing efficiency and reliability. The use of T-splitter 601 in the present invention is practical in instances where one force of air from bellow is designed to have two results such as the inflation of two independent airbags in two extensions. As previously mentioned, this may be required in order to allow two ears to independently “perk up” or two eyebrows to independently rise.

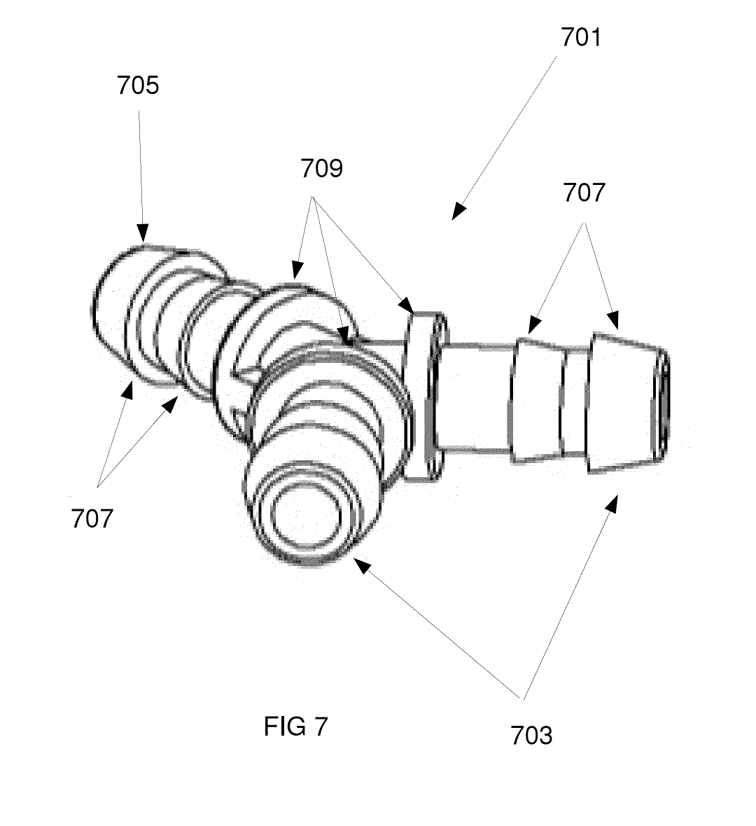

Another embodiment may utilize a Y-splitter as depicted in FIG. 7. Y-splitter 701 acts in a substantially similar manner to T-splitter presented in FIG. 6. Y-splitter 701 comprises comprises two air bag fitting ends 703 designed to connect to two, ultimately independent air bags. Y-splitter 701 is configured with adapting ridges 707 to increase the tightness of the fit between the air bag fitting ends 703 and the air bags. Y-splitter 701 has a third, flexible hose fitting end 705 which is designed to be connected to a flexible hose. Flexible hose fitting end 705 is configured with adapting ridges 707 to increase the tightness of the fit between the flexible hose fitting end 705 and the flexible hose. Both the air bag fitting ends 703 and flexible hose fitting end 705 are configured with hose stops 709 which act as a final terminus for the connected air bags 109 and flexible hose 105. The hose stops 709 ensure proper fit of all attaching hoses thereby increasing efficiency and reliability. By adding a Y-splitter, two opposing air hoses can travel to unique points within a slipper and ultimately independent air bags in the slipper. Such a configuration may be useful in instances where it is desired that the front of slipper exhibit animation while the rear of slipper also exhibits generally unrelated animation. For example, in a dog novelty slipper, the mouth at the front of the slipper can be designed to open while a tail located at the rear of the slipper can be designed to “wag.” Of course one of ordinary skill in the art will readily recognize that the same function may be accomplished with the use of multiple bellows positioned at any portion of the slipper such as a bellow designed to be compressed by a wearer's heel and a second bellow designed to be compressed by a wearer's toe.

Further detailing the system and apparatus presented in FIG. 1 and FIG. 2, FIG. 8 depicts an expended top view of the air bag 109 of the preferred embodiment of the present invention. Air bag 109 is shown in its actuated, and thereby inflated, state. The air bag 109 is configured to accept a flow of fluid, in this case air, from a flexible hose affixed at air bag opening 801. The flexible hose may be attached to a connector or depending on the desired structure integrated with and directly attached to a bellow. In this particular embodiment, air bag 109 is configured with an upper restraining pocket 210 and a lower restraining pocket 803. Upper restraining pocket 210 and lower restraining pocket 803 are configured to loosely restrain flat tension 212 such that it is afforded movement less than what is required to dislodge it from communication with air bag 109. Restraining bands 213 are utilized to restrain flat tension but to allow it to move as required as air bag 109 is inflated.

While certain aspects of the device are presented below in certain claim forms, the inventor contemplates the various aspects of the system in any number of claim forms. Accordingly, the inventor reserves the right to add additional claims after filing the application to pursue such additional claim forms for other aspects of the system.

Thus, there has been summarized and outlined, generally in broad form, a plurality of the most important features of the present invention. While this summary is presented so that the novelty of the present contribution to the related art may be better appreciated, it will further be apparent that additional features of the invention described hereinafter (which will form the subject matter of the claims appended hereto) will further define the scope, novelty, and, in certain instances, the improvements upon any existing art. The following description provides specific details for a thorough understanding of, and enabling description for, various examples of the technology. One skilled in the art will understand that the technology may be practiced without many of these details and it is to be readily understood that the invention presented herein is not limited in its application to the details of construction and to the arrangements of the components set forth in the following description or illustrated in the various figures integrated and categorized herein. For example, in some instances, well-known structures and functions have not been shown or described in detail to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Those skilled in the art will appreciate that the disclosure of the present invention may readily be utilized as a basis for the designing of other similar structures, methods and systems for carrying out the various purposes and objectives of the present invention. Thus, the claims as set forth shall allow for such equivalent constructions insofar as they do not depart from the spirit and scope of the present invention as described herein.

What is claimed is:

1. An inflation system comprising,
a. at least one air bag;
b. a bellow connected to said at least one air bag; and,
c. at least one flat tension disposed in communication with said at least one air bag.

2. An inflation system as claimed in claim 1 wherein the at least one flat tension is restrained to the at least one air bag at a top end and a bottom end of the at least one flat tension.

3. An inflation system as claimed in claim 1 wherein the bellow is connected to the at least one air bag by a flexible air hose.

4. An inflation system as claimed in claim 1 wherein the bellow is connected to a splitter by an air hose, said splitter having at least two flexible air hoses connecting to at least two air bags.

5. An article of toy character animation footwear using an air bag and bellow system comprising,
a. An article of footwear defined by a bottom sole portion and a top portion;
b. A character disposed at the top portion of the footwear;
c. a static actuation position defined by a deflated air bag cooperating with a flat tension creating minimum system length and volume; and,
d. A second actuated position that has an increased volume due to the cooperating flat tension being flipped over center by the air bag creating a new volume that is increased in volume.

6. An article of footwear as in claim 6 further comprising at least one protrusion from an area on the bottom portion, said at least one protrusion is capable of actuation.

7. An article of footwear as in claim 6 wherein the deflated air bag is a flat bent deflated air bag.

8. An article of footwear comprising:
a. a cushioned sole and cushioned upper portion;
b. a closed inflation system utilizing a plurality of air bags, a plurality of bellows connected to said air bags; and a plurality of flat tension disposed in communication with said plurality of air bags; and
c. an extension for creating an animation function.

9. The article of footwear as in claim 8 wherein the cushioned sole and cushioned upper portion are manufactured of polyester.

10. The article of footwear as in claim 8 wherein the plurality of air bags are manufactured of plastic and utilize an anti-static powder substance to prevent sticking of the internal portions of the plurality of air bags.

11. The article of footwear as in claim 8 wherein the cushioned sole and cushioned upper portion are manufactured of polyester and silk.

12. The article of footwear as in claim 8 wherein the cushioned sole and cushioned upper portion are manufactured of a material selected from the group of cotton, synthetic fiber, and silk.

13. The article of footwear as in claim 8 wherein at least one of the plurality of air bags is a flat deflated air bag in its static state prior to actuation.

14. The article of footwear as in claim 8 wherein the plurality of air bags are actuated as a result of the bipedal movement of a wearer.

15. The article of footwear as in claim 8 wherein at least one of the plurality of flat tensions is restrained to the at least one air bag at a top end and a bottom end of the at least one flat tension.

16. The article of footwear as in claim 8 wherein said cushioned sole includes resilient foam padding.

17. The article of footwear as in claim 8 wherein said footwear is a slipper.

18. The article of footwear as in claim 8 wherein said footwear is a tennis shoe.

19. The article of footwear as in claim 8 wherein said footwear is a loafer.

20. The article of footwear as in claim 8 wherein said closed inflation system includes a plurality of air hoses.
